(19) United States
(12) Patent Application Publication
(10) Pub. No.: US 2025/0067857 A1
(43) Pub. Date: Feb. 27, 2025

(54) SYSTEMS, APPARATUSES, AND METHODS FOR ONLINE CALIBRATION OF RANGE SENSORS FOR ROBOTS

(71) Applicant: Brain Corporation, San Diego, CA (US)

(72) Inventors: Simon Couture, San Diego, CA (US); Oleg Sinavski, San Diego, CA (US)

(21) Appl. No.: 18/238,441

(22) Filed: Aug. 25, 2023

(51) Int. Cl. G01S 7/497; G01S 17/89; G05D 1/02; G06T 17/20

(52) U.S. Cl. CPC G01S 7/4972; G01S 17/89; G06T 17/20

(57) ABSTRACT

Systems, apparatuses, and methods for online calibration of range sensors for robots are disclosed herein. According to at least one non-limiting exemplary embodiment, a controller of a robot may sense a portion of the robot within a range measurement and use the location of the sensed portion to determine a position of the range sensor, and accordingly adjust the pose of the sensor as needed.

### PRIORITY

This application is a continuation of International Patent Application No. PCT/US22/18090 filed Feb. 28, 2022 and claims priority to U.S. provisional patent application No. 63/154,365 filed Feb. 26, 2021 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems, apparatuses, and methods for online calibration of range sensors for robots.

### SUMMARY

The foregoing needs are satisfied by the present disclosure, which provides for, inter alia, systems, apparatuses, and methods for online calibration of range sensors for robots.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a robot is disclosed. The robot, comprises: at least one range sensor; and a non-transitory computer readable storage medium comprising computer readable instructions stored thereon which, when executed by a controller of the robot, causes the robot to: receive measurement from the at least one range sensor, the measurement comprises of a plurality of points each corresponding to respective range measurements made by the at least one range sensor: detect a contour of the robot within the measurement: determine a position of the at least one range sensor based on a discrepancy between the contour of the robot within the measurement and a reference location of the contour.

According to at least one non-limiting exemplary embodiment, the controller is further configured to execute the instructions to: determine the position of the range sensor based on aligning the contour of the robot with the reference location, the alignment corresponding to a spatial transformation corresponding to a change in position of the at least one range sensor from a respective default position.

According to at least one non-limiting exemplary embodiment, the at least one range sensor includes a field of view which encompasses at least a portion of the robot, the portion of the robot comprises the contour.

According to at least one non-limiting exemplary embodiment, the at least one range sensor comprises one of a planar LiDAR, three dimensional LiDAR, or depth camera.

According to at least one non-limiting exemplary embodiment, the controller is further configured to execute the instructions to: detect the contour of the robot based on detection of a sharp increase in range measurements along a direction away from the robot.

According to at least one non-limiting exemplary embodiment, the controller is further configured to execute the instructions to: utilize a three-dimensional mesh model of the robot to determine the reference location of the detected contour.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 illustrates various transforms used by robots to localize themselves and track the position of their sensors in accordance with exemplary embodiments of this disclosure.

FIG. 3A(i-ii) illustrates a planar light detection and ranging (LiDAR) sensor, according to an exemplary embodiment.

FIG. 3B illustrates a depth camera and components thereof, according to an exemplary embodiment.

FIG. 4A is a frontward view showing a robot detecting a portion of itself using a range sensor, according to an exemplary embodiment.

FIG. 4B is a top-down view of a robot detecting a portion of itself using a range sensor, according to an exemplary embodiment.

FIG. 5(i) illustrates a depth image captured by a depth camera on a robot, according to an exemplary embodiment.

FIG. 5(ii) illustrates range measurements of a depth image along a y-axis, according to an exemplary embodiment.

FIG. 6 illustrates an alignment of a detected contour of a robot within a range measurement to a location on a 3-dimensional model of the robot, according to an exemplary embodiment.

FIG. 7 is a process flow diagram illustrating a method for a robot to calibrate a range sensor, according to an exemplary embodiment.

All Figures disclosed herein are @ Copyright 2021 Brain Corporation. All rights reserved.

### DETAILED DESCRIPTION

Currently, robots utilize various range sensors to perceive their environments. Such range sensors may include planar light detection and ranging (“LiDAR”) sensor, three-dimensional LiDARs, depth cameras, and the like. These sensors may be utilized to determine the presence and location of objects such that the robots may avoid collision. Accurate calibration of these range sensors may be essential for safe and efficient operation of a robot. Accordingly, the systems and methods disclosed herein enable online calibration of range measuring sensors for robots.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems, apparatuses, and methods for online calibration of range sensors for robots. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYSR, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, online calibration of a sensor corresponds to real time calibration of the sensor while a robot is operating.

As used herein, a default pose or position of a sensor corresponds to a well calibrated position or pose of the sensor. Default poses are typically pre-defined, e.g., by a manufacturer of the robot to ensure safe and efficient operation of the robot. Deviation of these sensors from their default poses may impose a safety risk to operating the robot if undetected and unaccounted for.

As used herein, network interfaces may include any signal, data, or software interface with a component, network, or process including, without limitation, those of the Fire Wire (e.g., FW400, FW800, FWS800T, FWS1600, FWS3200, etc.), universal serial bus (“USB”) (e.g., USB 1.X. USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated by a skilled artisan that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to reliably calibrate range measuring sensors, and (ii) improve safety and efficiency of operating robots by ensuring sensors are always in known positions during operation. Other advantages are readily discernable by one having ordinary skill in the art given the contents of the present disclosure.

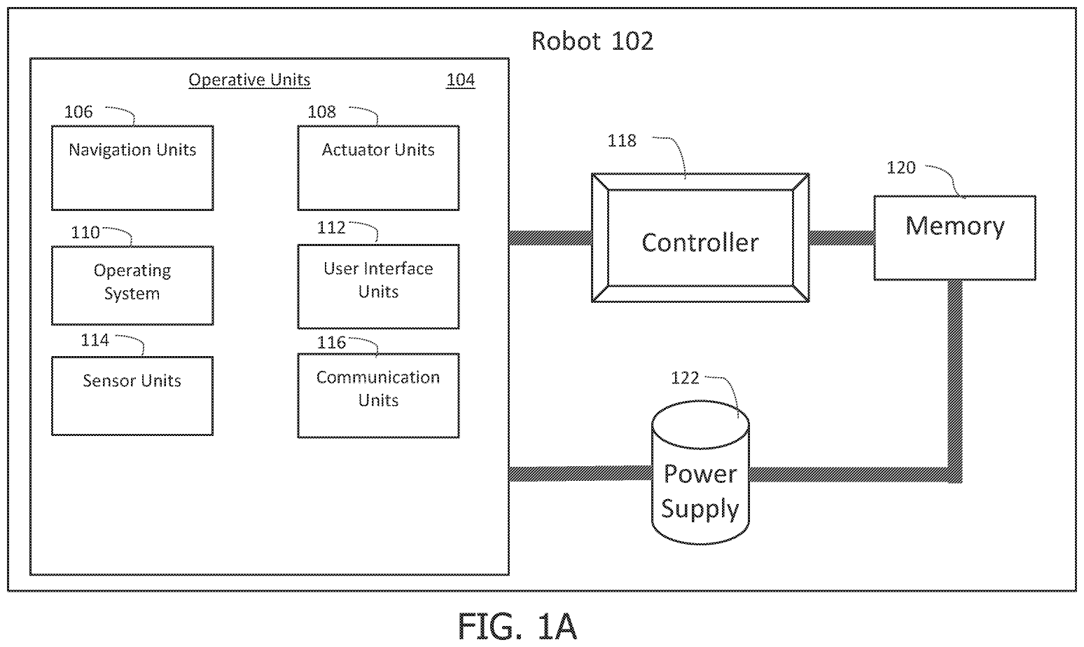

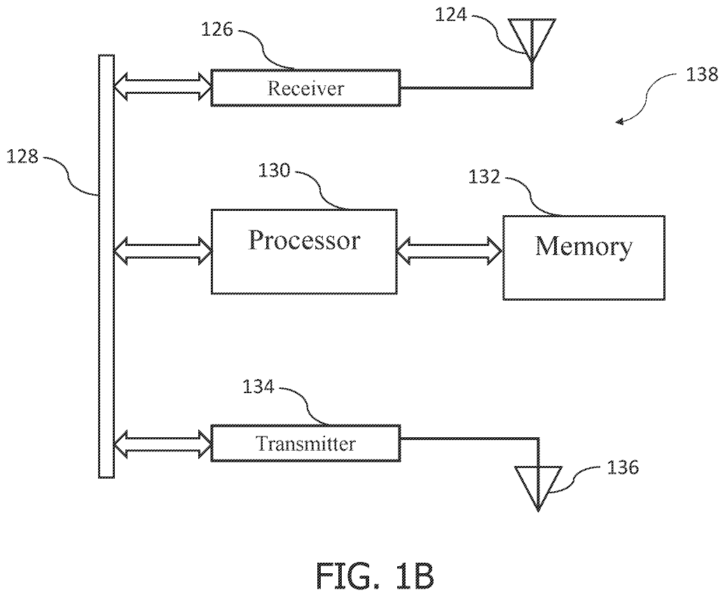

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it may be appreciated by a skilled artisan that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e,g., NAND/NOR), memristor memory, pseudostatic RAM (“PSRAM”), etc, Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route: navigate around obstacles: rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate it so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may illustrate an external server architecture configurable to effectuate the control of a robotic apparatus from a remote location, such as server illustrated. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

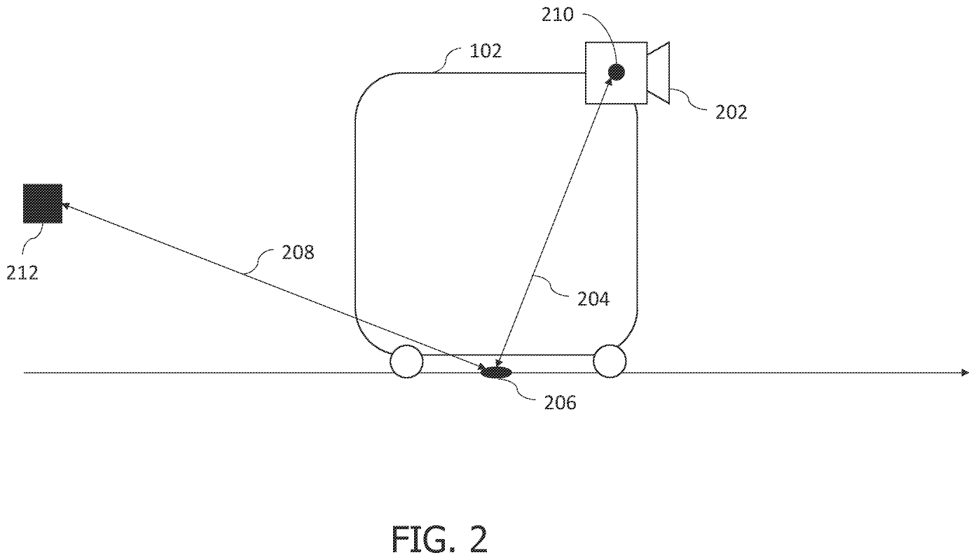

FIG. 2 illustrates a robot 102 comprising an origin 206 defined based on a transformation 208 from a world origin 212, according to an exemplary embodiment. World origin 212 may comprise a fixed or stationary point in an environment of the robot 102 which defines a (0,0,0) point within the environment. Origin 206 of the robot 102 may define a location of the robot 102 within its environment. For example, if the robot 102 is at a location (x=5 m, y=5 m, z=0 m), then origin 206 is at a location (5, 5, 0) with respect to the world origin 212. The origin 206 may be positioned anywhere inside or outside the robot 102 body such as, for example, between two wheels of the robot at z=0 (i.e., on the floor). The transform 208 may represent a matrix of values which configures a change in coordinates from being centered about the world origin 212 to the origin 206 of the robot 102. The value(s) of transform 208 may be based on a current position of the robot 102 and may change over time as the robot 102 moves, wherein the current position may be determined via navigation units 106 and/or using data from sensor units 114 of the robot 102.

The robot 102 may include one or more exteroceptive sensors 202 of sensor units 114, wherein each sensor 202 includes a respective origin 210. Measurements from the sensor 202 may include, for example, distance or range measurements, wherein the distances measured correspond to a distance from the origin 210 of the sensor 202 to one or more objects. Transform 204 may define a coordinate shift from being centered about an origin 210 of the sensor 202 to the origin 206 of the robot 102, or vice versa. To illustrate, transform 204 may translate a 5 m range measurement from the origin 210 of the sensor 202 to a distance/location defined with respect to robot origin 206. Transform 204 may be a fixed value, provided the sensor 202 does not change its position, however the position often drifts during normal operation of the robot 102 due to vibrations, bumps, and other normal perturbations. Accordingly, it is advantageous for controller 118 to track the pose of the origin 210 of the sensor 202 such that transform 204 is accurately defined. Precise measurement of transform 204 may be determined using the systems and methods disclosed below.

It may be appreciated by a skilled artisan that the position of the sensor 202 on the robot 102 is not intended to be limiting. Rather, sensor 202 may be positioned anywhere on the robot 102 and transform 204 may denote a coordinate transformation from being centered about the robot origin 206 to the sensor origin 210 wherever the sensor origin 210 may be. Further, robot 102 may include two or more sensors 202 in some embodiments, wherein there may be two or more respective transforms 204 which denote the locations of the origins 210 of the two or more sensors 202. Similarly, the relative position of the robot 102 and world origin 212 as illustrated is not intended to be limiting.

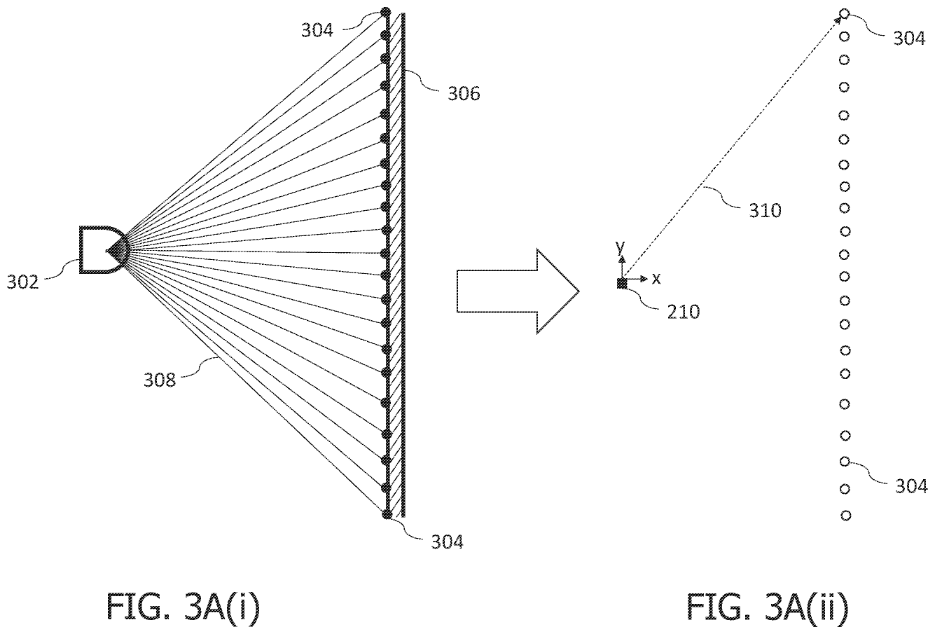

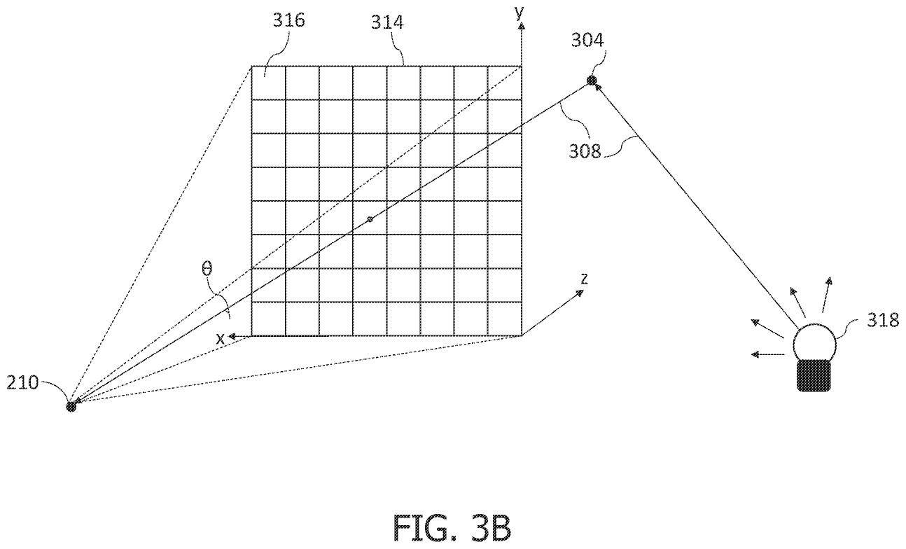

FIG. 3A(i-ii) illustrates a planar light detection and ranging (“LiDAR”) sensor 302 coupled to a robot 102, which collects distance measurements to a wall 306 along a measurement plane in accordance with some exemplary embodiments of the present disclosure. Planar LiDAR sensor 302, illustrated in FIG. 3A(i), may be configured to collect distance measurements to the wall 306 by projecting a plurality of beams 308 of photons at discrete angles along a measurement plane and determining the distance to the wall 306 based on a time of flight (“ToF”) of the photons leaving the LiDAR sensor 302, reflecting off the wall 306, and returning back to the LiDAR sensor 302. The measurement plane of the planar LiDAR 302 comprises a plane along which the beams 308 are emitted which, for this exemplary embodiment illustrated, is the plane of the page.

Individual beams 308 of photons may localize respective points 304 of the wall 306 in a point cloud, the point cloud comprising a plurality of points 304 localized in 2D or 3D space as illustrated in FIG. 3A(ii). The points 304 may be defined about a local origin 210 of the sensor 302. Distance to a point 304 from origin 210 may comprise half the time of flight of a photon of a respective beam 308 used to measure the point 304 multiplied by the speed of light, wherein coordinate values (x, y) of each respective point 304 depends both on distance 312 and an angle at which the respective beam 308 was emitted from the sensor 302. The local origin 310 may comprise a predefined point of the sensor 302 to which all distance measurements are referenced (e.g., location of a detector within the sensor 302, focal point of a lens of sensor 302, etc.). For example, a 5-meter distance measurement to an object corresponds to 5 meters from the local origin 310 to the object.

According to at least one non-limiting exemplary embodiment, sensor 302 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 308 along a plane as illustrated or in a predetermined pattern (e.g., a circle or series of separated parallel lines).

FIG. 3B illustrates components and operation principles of a depth camera in accordance with some exemplary embodiments of this disclosure. Depth cameras may comprise of two main components: (i) an emitter 318 and (ii) a detector component. The emitter 318 may comprise of a light source configured to emit pulses or flashes of (encoded) light into the environment. This light may travel into the environment and be received by the detector component. When the light is received by the detector, the path of the light may be mapped to a pixel 316 of an image plane 314 of the depth camera, as shown by the path of beam 308 representing one path of many beams which are emitted from emitter 318 but omitted from the drawing for clarity. The detector component may comprise the origin 210 of the depth camera as the image mapping and range are measured from the perspective of the detector. Although the emitter 318 is illustrated as being spatially separate from the origin 210 of the depth camera, one skilled in the art may appreciate that this depiction is for illustrative clarity only.

Depth cameras operate differently from scanning planar or three-dimensional LiDARs in that depth cameras emit a plurality of beams 308 simultaneously from emitter 318 (i.e., a flash of light) which are received by the receiver at approximately the same time(s). A collection of range measurements for each pixel 316 of the image plane 314 received following a given flash or pulse from emitter 318 may be referred to as a depth image.

Image plane 314 may comprise a size (i.e., width and height) corresponding to a field of view of the depth camera. Image plane 314 may comprise a plane upon which a visual scene is projected on to produce, for example, images (e.g., RGB images, depth images, etc.). The image plane 314 is analogous to the plane formed by a printed photograph on which a visual scene is depicted. The image plane 314 subtends a solid angle about the origin 210 corresponding to a field of view of the sensor 302, the field of view being illustrated by dashed lines which denote the edges of the field of view. The image plane 314 comprises a resolution defined by a number of pixels 316 along opposing width and height dimensions (x, y). Pixels 316 of the image plane 314 may correspond to individual pixels of a CCD array, or other photo array, of the receiver.

Image plane 314 may include a plurality of pixels 316. Each pixel 316 may include or be encoded with distance information and, in some instances, color information. The distance information is based on a ToF of a beam 208 associated with the pixel 316. If the depth camera 302 is configured to produce colorized depth imagery, each pixel 316 of the plane 302 may include a color value equal to the color of the visual scene as perceived by a point observer at a location of a sensor origin 210 (e.g., using data from color-sensitive sensors such as CCDs and optical filters). The distance information may correspond to a ToF of a beam 308 emitted from the emitter 318, reflecting off an object, traveling through a pixel 316 of the image plane 314 (the intersection of the beam 308 with a pixel 316 of the image plane 314 is shown with a dot in the center of the pixel 316), and being sensed by the detector, wherein the point 304 may be localized on the surface of the object. The location of the point 304 is determined based on the ToF of the beam 308 (i.e., the range) and the specific pixel 316 the beam 308 passes through. The distance measurement may be based on a ToF of a beam 308 emitted at the origin 210, passing through a pixel 316, and reflecting off an object in the visual scene back to the depth camera 302. The distance and color information for each pixel 316 may be stored as a matrix in memory 120 or as an array (e.g., by concatenating rows/columns of distance and color information for each pixel 316) in memory 120 of a robot 102.

For planar LiDAR sensors configured to measure distance along a measurement plane, the image plane 314 may instead comprise a one-dimensional (i.e., linear) row of pixels 316. The number of pixels 316 along the row may correspond to the angular resolution of the planar LiDAR sensor.

By way of an analogous visual illustration, if the image plane 314 is an opaque surface and one pixel 316 is removed or made transparent to allow for viewing of a visual scene behind the opaque surface through the “removed/transparent” pixel 316, the color value of the pixel 316 may be the color seen by an observer at the origin 210 looking through the “removed/transparent” pixel 316. Similarly, the depth value may correspond to the distance between the origin 210 to an object as traveled by a beam 308 through the “removed” pixel 316. It is appreciated, following the analogy, that depth cameras 302 may “look” through each pixel contemporaneously by emitting flashes or pulses of beams 308 from emitter 318.

The number of pixels 316 may correspond to the resolution of the depth camera 302. In the illustrated embodiment, simplified for clarity, the resolution is only 8×8 pixels, however one skilled in the art may appreciate depth cameras may include higher resolutions such as, for example, 480×480 pixels, 1080×1080 pixels, or larger. Further, the resolution of the depth camera 302 is not required to include the same number of pixels along the horizontal (i.e., x) axis as the vertical (i.e., y) axis.

The size (in steradians) of the pixels 316 may correspond to a resolution of the resulting depth image and/or sensor. The angular separation between two horizontally adjacent beams θ may be the angular resolution of the depth image, wherein the vertical angular resolution may be of the same or different value.

Depth imagery may be utilized to produce a point cloud, or a plurality of localized points 304 in 3-dimensional (“3D”) space, each point 304 comprising no volume and a defined (x, y, z) position. Each point typically comprises non-integer (i.e., non-discrete) values for (x, y, z), such as floating-point values. It may be desirable for a robot 102 to accurately localize objects within its environment to avoid collisions and/or perform tasks using its depth cameras and/or LiDAR sensors 302. Accordingly, accurate and persistent calibration of these sensors must be performed in order to maintain safe and efficient operation of the robot 102.

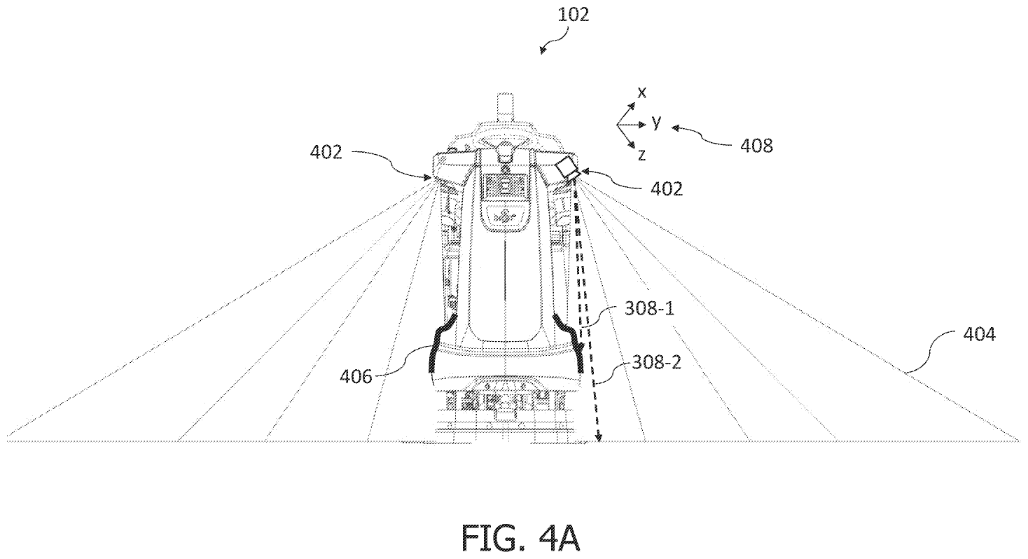

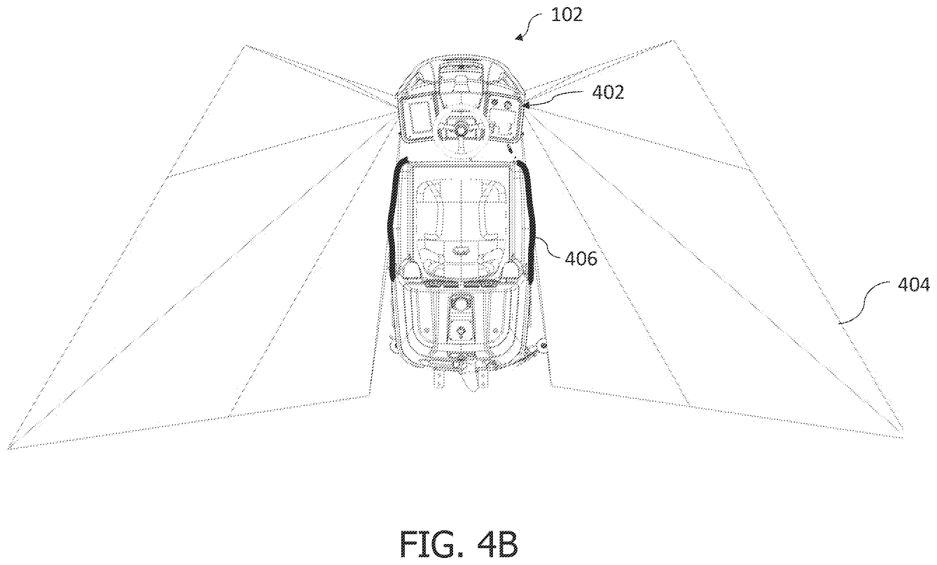

FIG. 4A is a front view of a robot 102 comprising two side depth cameras 402 on either side of the robot 102, according to an exemplary embodiment. One of the two depth cameras 402 is illustrated for clarity; however, it may be appreciated by a skilled artisan that the depth cameras are embedded within the chassis of the robot 102 and are obstructed from view. The two depth cameras 402 each comprise respective fields of view shown by field of view lines 404. These depth cameras 402 may be configured to detect objects nearby the sides of the robot 102. The two depth cameras 402 each further comprise a field of view, which encompasses at least a portion of the robot 102 shown by contour 406. Contour 406 is highlighted with emboldened lines illustrating the portion of the robot 102 sensed by the depth cameras 402. The reference axis 408 correspond to the image-plane axis of the right depth camera 402.

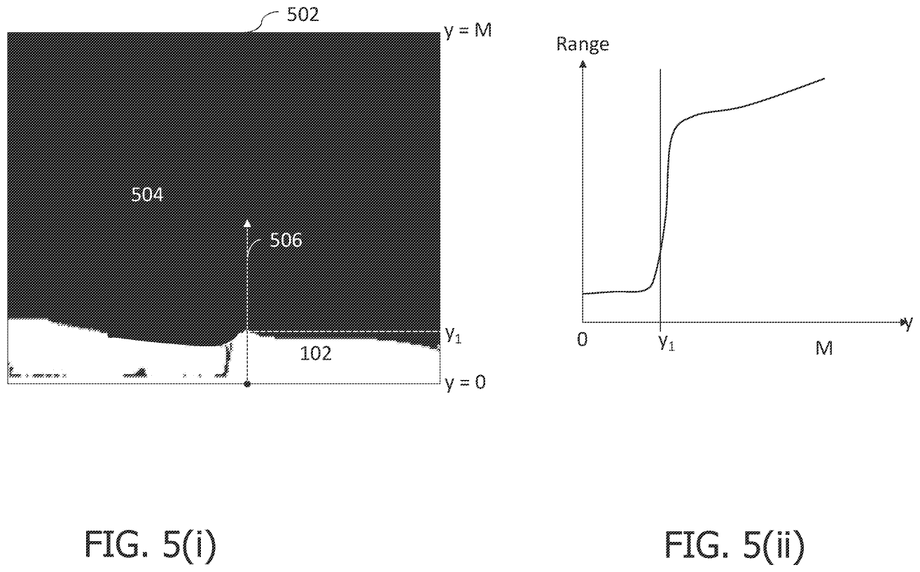

FIG. 4B shows the same contours 406 being detected by the side depth cameras 402 from a top-down view of the robot 102, according to an exemplary embodiment. The top-down view is intended to provide additional visual reference for the shape of the contour 406 in the following figures. As shown from the top-down view, the fields of view 404 of the depth cameras 402 encompass contour 406 of the robot 102 such that depth images captured by these depth cameras 402 depict, at least in part, a portion of the robot 102 body, as shown next in FIG. 5(i).

Robot 102 in FIGS. 4A-B comprises a floor cleaning robot 102. One skilled in the art may appreciate that the systems and methods of the present disclosure are applicable to any robot 102 comprising range sensors which sense a portion of the robot body and are not intended to be limited to the illustrated robot 102.

FIG. 5(i) illustrates a depth image 502 received from a side depth camera 402 of the robot 102 shown in FIGS. 4A-B above, according to an exemplary embodiment. Color values of the pixels of the depth image 502 may represent a range/distance measurement, wherein white pixels are shorter ranges and black pixels are longer ranges. The white portion of the depth image represents the portion of the robot 102 sensed by the depth cameras 402. The remaining black portion 504 illustrates floor surrounding the robot 102. To detect the pixels of the depth image 502, which represent the robot 102, controller 118 may detect a sudden increase in range measurements along the y-axis (also shown in FIG. 4A by reference coordinates 408). This sudden increase in range measurements corresponds to the drop-off between the portion of the robot 102 and the floor. As shown in FIG. 4A for example, the contour 406 is sensed or detected by at least two beams 308-1, 308-2. The two beams 308-1, 308-2 represent two beams 308 that are adjacent in the image plane pixels 316. Beam 308-1 illustrates the last beam 308 along the y-axis which detects the robot 102 and beam 308-2 represents the first beam along the y-axis which detects the floor or an object (if present), other than the robot 102. The y-axis of the depth image 502 is shown by reference axis 408 as the direction away from the robot 102 body. As shown by the length of the beams 308-1, 308-2, there is a sudden increase in range measurements moving along the y-axis due to the edge of the robot 102 (specifically contour 406) being sensed by the depth cameras 402.

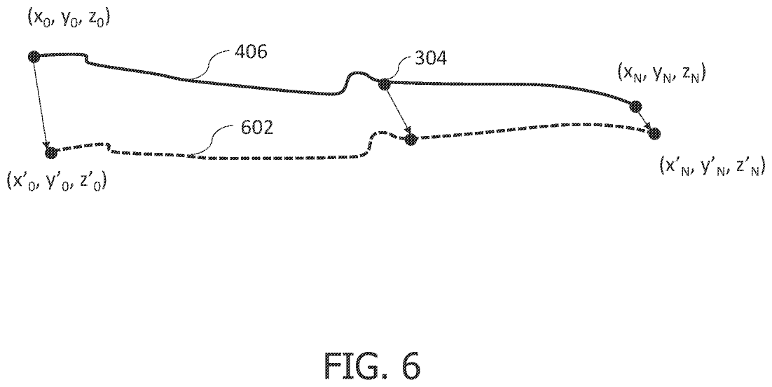

Returning again to FIG. 5(i), arrow 506 represents the controller 118 parsing range measurements of the depth image 502 along the y-axis for a given column of pixels. Value y₁ corresponds to the y-value of the last pixel that represents the contour 406 of the robot 102 body. FIG. 5(ii) shows a graph of range measurements when moving in the positive y-direction along arrow 506, according to an exemplary embodiment. As shown, there is a sudden increase in range measurements around the pixel at y₁, indicating that pixel y₁ is the edge of the robot 102. Controller 118 may detect the sudden increase based on the derivative of dR/dy exceeding a threshold, wherein dR represents the change in range measurements with respect to a change in y (i.e., dy). Controller 118 may detect the edge of the robot 102 for each column of pixels of the depth image 502 to determine the location of the contour 406 in the depth image. Contour 406 corresponds to the line (along approximately the x-axis) of pixels that are the final pixels along the y-axis, which depict the robot 102 body. An exemplary contour detected from the depth image 502 is shown in FIG. 6.

According to at least one non-limiting exemplary embodiment, controller 118 may detect a predetermined number of pixels, which represent the edge of the robot 102 and linearly or non-linearly interpolate between these pixels to define the contour 406.

It may be appreciated by a skilled artisan that if the depth camera 402 is well calibrated and in its default position; controller 118 should expect to see the contour 406 in every depth image at the same location in three-dimensional space. However, over time, the pose of the depth cameras 402 may drift, causing the location of the contour 406 in depth images 502 to be different from the expected location. The change in position of this contour may correspond to the change in position of the depth camera, as will be explained further below with respect to FIG. 6.

FIG. 6 illustrates a controller 118 of a robot 102 determining a change in position of a depth camera coupled to the robot 102, according to an exemplary embodiment. Contour 406 comprises an edge of the robot 102 as seen within depth images 502 captured by a calibrated depth camera, as shown in FIGS. 4-5 above. The contour 406 may include a plurality of points thereon, the points may correspond to pixels of the depth image 502 or points 304 of a point cloud. Each point may include a defined position in 3D space based on the location and range associated with each point 304. Illustrated are three points 304 on the contour 406, the three points comprise (x, y, z) coordinates; however, more points (not illustrated) may be included.

Controller 118 may utilize a 3D model of the robot 102 stored in its memory to determine where on the 3D model the contour 406 exists. Upon locating a corresponding contour 602 on the 3D model of the robot 102, controller 118 may determine a spatial discrepancy between the detected contour 402 and the reference contour 602. The spatial discrepancy may include rotations and/or translations. These rotations/translations, which configure contour 406 to match contour 602 may correspond to the rotations/translations experienced by the depth camera from its default position or the well calibrated position. Controller 118 may determine the rotations/translations needed to align contour 406 to reference contour 602 using algorithms such as iterative closest point (ICP) that minimizes the distance between two points.

The 3D model may be a mesh model or other simplified model of the robot 102 in order to reduce the computational complexity of analyzing the model to find the reference contour 602 which matches contour 406.

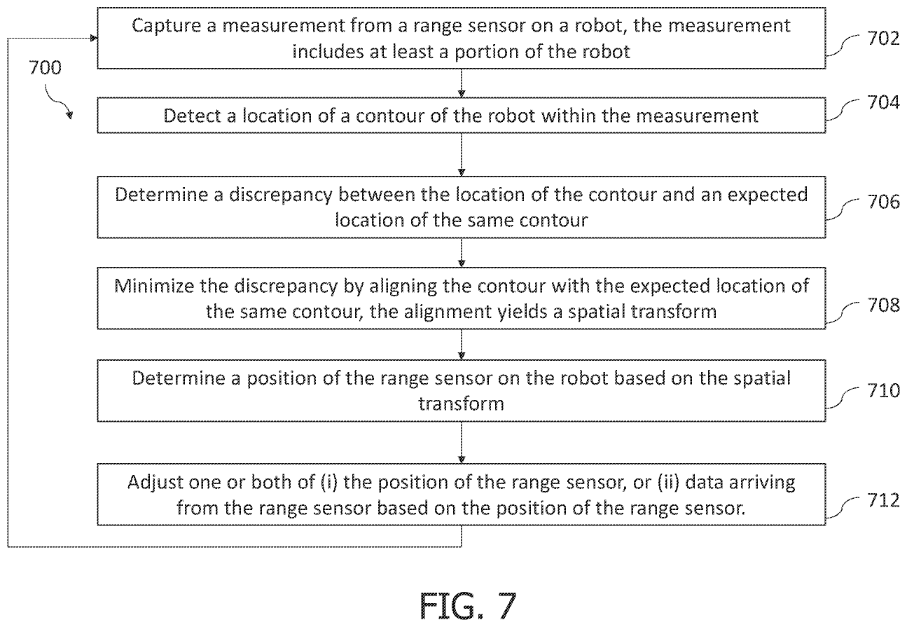

FIG. 7 is a process flow diagram illustrating a method 700 for a controller 118 to calibrate a range sensor, according to an exemplary embodiment. A range sensor may comprise of a planar LiDAR sensor, 3D LiDAR, depth camera, and/or other sensors configured to measure range/distance and localize points in 3D space. Steps of method 700 may be effectuated via the controller 118 executing computer readable instructions from memory 120.

Block 702 includes the controller 118 capturing a measurement from the range sensor on the robot 102. The range sensor is configured to include a field of view which encompasses a portion of the robot 102, wherein the measurement includes at least a portion of the robot 102. The measurement may comprise of a depth image, LiDAR scan, or other collection of points 304.

Block 704 includes the controller 118 detecting a contour 406 of the robot 102 within the measurement. The contour 406 comprises an edge of the portion of the robot 102 seen within the measurement. Controller 118 may detect the contour 406 based on detection of a sudden increase in range measurements moving along an axis away from the robot 102 body, such as the y-axis shown in FIG. 5(i-ii) for example. The increase in range is shown via an exemplary embodiment in FIG. 4A by beams 308-1 and 308-2.

According to at least one non-limiting exemplary embodiment, controller 118 may also utilize color occurrence analysis to detect the contour 406 of the robot 102, provided the measurement from the range sensor comprises color data. Controller 118 may search for reference color(s) within captured colored depth images to detect pixels that depict the robot 102, the reference color(s) corresponding to the color(s) of the robot 102.

According to at least one non-limiting exemplary embodiment, the controller 118 may also utilize motion analysis to detect the contour 406 of the robot 102. The motion analysis may indicate portions of acquired depth imagery or LiDAR scans which are static or moving. The static portions correspond to the portions of the robot 102 sensed within the measurement, whereas the moving portions correspond to the floor and surrounding environment. The contour 406 may comprise of a row of static pixels/points 304 closest to the moving pixels/points 304.

Block 706 includes the controller 118 determining a discrepancy between the location of the contour and an expected location of the same contour. In some embodiments, the expected location may be determined based on use of a 3D model of the robot 102 stored in memory 120. Controller 118 may utilize the 3D model to determine where on the robot 102 the detected contour 406 best fits. That is, the controller 118 may rotate/translate the contour 406 until detecting where on the robot 102 the contour 406 best matches the 3D model. Based on the location of the detected contour 406 on the 3D model, the controller 118 may utilize the range measurements of the contour 406 to determine the position of the range sensor in the blocks 708-710 below.

According to at least one non-limiting exemplary embodiment, the reference contour may be a pre-determined portion of the robot 102. The pre-determined reference contour includes a pre-determined position stored in memory 120, the position corresponding to the position that the range sensor detects the contour if the range sensor is in its default position. However, discrepancies in the measured position and the reference position may correspond to discrepancies in the position of the range sensor from its default position. Accordingly, the transformations needed to align the detected contour 406 with the reference contour correspond to the transformations needed to move the range sensor back into its default position.

Block 708 includes the controller 118 minimizing the spatial discrepancy between the location of the detected contour 406 and the reference contour by transforming (i.e., rotating and/or translating) the detected contour 406 until the detected contour 406 matches with the reference contour. Controller 118 may utilize, for example, the ICP algorithm to align the detected contour 406 with the reference contour, wherein ICP outputs the transform needed to perform the alignment.

Block 710 includes the controller 118 determining the position of the range sensor on the robot 102 based on the alignment performed in block 708. To illustrate, if the detected contour 406 is moved by an amount along the x-axis to align with the reference contour, the range sensor may have drifted by the same amount along the x-axis from its default position. In short, the transformations performed on the detected contour 406 to align it with the reference contour corresponds to the transformation of position from the default position of the range sensor.

Block 712 includes the controller 118 adjusting one or both of (i) the position of the range sensor, and/or (ii) data arriving from the range sensor based on the determined position of the range sensor. First, some robots 102 may include actuators coupled to sensors to adjust their position. Accordingly, controller 118 may issue commands to these actuators to adjust the position of the sensor in accordance with its current pose and the difference between the current pose and the default pose in order to align the transformations performed on the detected contour with the reference contour. Alternatively, a human operator may be called to manually adjust the position of the range sensor. Data arriving from the range sensor may also be adjusted using a digital filter. The digital filter modifies data arriving from the range sensor to account for its drift in position. Specifically, the digital filter updates the transform 204 shown in FIG. 2 above to represent the true position of the origin more accurately 210 of the range sensor.

Method 700 is shown as being a cyclic process indicating that, for each measurement acquired by the range sensor, the controller 118 is able to calibrate the range sensor. One skilled in the art may appreciate that method 700 may repeat for each and every measurement received, for every other measurement received, after a given delay (e.g., calibrate every 10 seconds or using one out of every 10 range measurements), or after the robot 102 travels a predetermined distance. That is, one skilled in the art may balance the amount of calibration performed by the controller 118 with computational limitations of the controller 118 and/or accuracy of calibration needed to ensure safe and effective operation of the robot 102, which may be based on the specific features of a given robot 102.

In some instances, the position of the range sensor may have drifted substantially from its default position. If controller 118 detects that the position of the range sensor deviates substantially from its default position, the controller 118 may stop the robot 102 due to safety concerns. For example, if the contour 406 is not sensed within the range measurement, controller 118 may stop the robot 102 due to the sensor deviating substantially from its default position. However, it may be appreciated by a skilled artisan that the method 700 may be executed a plurality of times while the robot 102 is operating with the adjustments made to the range sensor or data therefrom being small, iterative adjustments (e.g., a few centimeters or degrees of rotation), wherein detecting a sudden large drift of a position of the range sensor is not a likely occurrence but may occur following a collision. It may be appreciated by a skilled artisan that robots 102 may typically comprise of additional safety measures not disclosed herein which may lower the likelihood of a collision and, following a collision, it is common for the robot 102 to cease to operate due to safety concerns which may or may not be related to the position of the range sensor.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for calibrating sensors on a robot, comprising:
receiving measurement from a range sensor, the measurement comprising of a plurality of points corresponding to a plurality of respective range measurements by the range sensor;
detecting, via a controller of the robot, a contour of the robot within the measurement;
determining, via the controller of the robot, a position of the range sensor based on a discrepancy between the contour of the robot within the measurement and a reference location of the contour.

2. The method of claim 1, further comprising:
determining, via the controller of the robot, the position of the range sensor based on aligning the contour of the robot with the reference location, the alignment corresponding to a spatial transformation.

3. The method of claim 1, wherein,
the range sensor comprises a field of view which encompasses at least a portion of the robot, the portion of the robot comprises the contour.

4. The method of claim 1, wherein,
the range sensor comprises one of a planar LiDAR, three dimensional LiDAR, or depth camera.

5. The method of claim 1, further comprising:
detecting, via the controller of the robot, the contour of the robot based on an increase in the range of measurements along a direction away from the robot which exceeds a threshold value.

6. The method of claim 1, further comprising:
utilizing, via the controller of the robot, a three-dimensional mesh model of the robot to determine the reference location of the detected contour.

7. A robot, comprising:
at least one range sensor; and
a non-transitory computer readable storage medium comprising computer readable instructions stored thereon which, that executed by a controller of the robot, causes the robot to:
receive measurement from the at least one range sensor, the measurement comprises of a plurality of points corresponding to a plurality of respective range measurements by the range sensor;
detect a contour of the robot within the measurement;
determine a position of the at least one range sensor based on a discrepancy between the contour of the robot within the measurement and a reference location of the contour detected.

8. The robot of claim 7, wherein the controller is further configured to execute the computer readable instructions to:
determine the position of the range sensor based on aligning the contour of the robot with the reference location of the contour, the alignment corresponding to a spatial transformation with respect to a change in position of the at least one range sensor from a respective default position.

9. The robot of claim 7, wherein,
the at least one range sensor comprises a field of view which encompasses at least a portion of the robot, the portion of the robot comprises the contour.

10. The robot of claim 7, wherein,
the at least one range sensor comprises one of a planar LiDAR, three dimensional LiDAR, or depth camera.

11. The robot of claim 7, wherein the controller is further configured to execute the computer readable instructions to:
detect the contour of the robot based on an increase in the range of measurements along a direction away from the robot which exceeds a threshold value.

12. The robot of claim 7, wherein the controller is further configured to execute the computer readable instructions to:
utilize a three-dimensional mesh model of the robot to determine the reference location of the detected contour.

13. A non-transitory computer readable storage medium comprising computer readable instructions stored thereon which, when executed by a controller of a robot, cause the controller to:
receive measurement from a range sensor, the measurement comprises of a plurality of points corresponding to a plurality of respective range measurements by the range sensor;
detect a contour of the robot within the measurement;
determine a position of the range sensor based on a discrepancy between the contour of the robot within the measurement and a reference location of the contour.

14. The non-transitory computer readable storage medium of claim 1, wherein the controller is further configured to execute the computer readable instructions to:
determine the position of the range sensor based on aligning the contour of the robot with the reference location of the contour, the alignment corresponding to a spatial transformation with respect to a change in position of the range sensor from a respective default position.

15. The non-transitory computer readable storage medium of claim 1, wherein,
the range sensor comprises a field of view which encompasses at least a portion of the robot, the portion of the robot comprises the contour.

16. The non-transitory computer readable storage medium of claim 1, wherein,
the range sensor comprises one of a planar LiDAR, three dimensional LiDAR, or a depth camera.

17. The non-transitory computer readable storage medium of claim 1, wherein the controller is further configured to execute the computer readable instructions to:
detect the contour of the robot based on an increase in the range of measurements along a direction away from the robot which exceeds a threshold value.

18. The non-transitory computer readable storage medium of claim 1, wherein the controller is further configured to execute the computer readable instructions to:
utilize a three-dimensional mesh model of the robot to determine the reference location of the detected contour.

19. A method for calibrating range sensors on a robot, comprising:
receiving a measurement from the range sensor, the measurement comprising of a plurality of points corresponding to a plurality of range measurements by the range sensor;
detecting, via a controller of the robot, a contour of the robot within the measurement by utilizing a three-dimensional mesh model of the robot to determine a reference location of the detected contour; and
determining, via the controller of the robot, a position of the range sensor based on a discrepancy between the contour of the robot within the measurement and the reference location of the contour,
wherein,
the range sensor comprises a field of view which encompasses at least a portion of the robot, the portion of the robot comprises the contour, and
the range sensor comprises one of a planar LiDAR, three dimensional LiDAR, or depth camera.
